(19) United States
(12) Patent Application Publication
(10) Pub. No.: US 2006/0179109 A1
(43) Pub. Date: Aug. 10, 2006

(54) Contents transmission system, method of playing contents using integration media play program, method of transmitting contents using media format transcoding function, and method of determining whether contents are transmitted

(75) Inventor: Seok-mo Ko, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/348,314

(22) Filed: Feb. 7, 2006

(30) Foreign Application Priority Data
Feb. 7, 2005 (KR) 2005-0011228

(51) Int. Cl. G06F 15/16

(52) U.S. Cl. 709/203

(57) ABSTRACT

A contents transmission system, a method of playing contents using an integration media play program, a method of transmitting contents using media format transcoding function, and a method of deciding whether the contents are transmitted. A home server of the contents transmission system includes a connector connected to a peripheral apparatus for interfacing various information transceived between the connector and the peripheral apparatus; a contents storage storing contents; and a contents list management unit reading out a list of contents stored in the peripheral apparatus, determining whether the read list is same as a contents list stored in the home server, and receiving untransmitted contents from the peripheral apparatus and storing the untransmitted contents in the contents storage when the contents lists are not same as each other.

### CROSS-REFERENCE TO RELATED APPLICATIONS

This application claims benefit under 35 U.S.C. §119 from Korean Patent Application No. 2005-11228 filed on Feb. 7, 2005 in the Korean Intellectual Property Office, the entire content of which is incorporated herein by reference.

### BACKGROUND OF THE INVENTION

1. Field of the Invention

The present invention relates to a contents transmission system, a method of playing contents using an integration media play program, a method of transmitting contents using a media format transcoding function, and a method of determining whether the contents have been transmitted.

2. Description of the Related Art

In recent years, attention has been focused on personal portable media players which enable digital contents such as movies and pictures to be viewed. The personal portable media players include apparatuses which enable various digital contents such as movies, music, pictures or the like, stored in a home server (or storage) to be downloaded and portably viewed. Representative examples of the personal portable media players include Dica-phones, Camcorder-phones, MP3-phones, MP3 players, Personal Digital Assistants (PDA) or the like. Hereinafter, the above-described kinds of personal portable media players are collectively referred to as ‘peripheral apparatuses’ for simplicity of technical description.

FIG. 1 is a view illustrating contents transmission between a home server and a conventional peripheral apparatus (e.g. personal portable media player). Referring to FIG. 1, personal computer (PC) 15 enables data to be transceived between the peripheral apparatus 10 and the home server 20. In this case, the peripheral apparatus 10 and the PC 15 are connected to each other by a universal serial bus cable (USB), and the PC 15 and the home server 20 are connected to each other via a network.

In this conventional contents transmission method, the PC 15 for mediating information transceived between the home server 20 and the peripheral apparatus 10 must exist, and the PC 15 and the peripheral apparatuses 10 must be connected to each other via a USB connector all the time, which makes users feel burdensome. Furthermore, in the conventional contents transmission method, there is no way of automatically discriminating between contents transmitted from the peripheral apparatus 10 to the home server 20 and untransmitted contents, which burdens the user. Further, the media formats of application programs held by respective peripheral apparatuses 10 are different, which makes it difficult to provide compatibility between the wide array of peripheral apparatuses 10 and the home server 20, so that a file transmission program such as a File Transfer Protocol (FTP) must also be used when transmitting the contents to the home server 20.

### SUMMARY OF THE INVENTION

It is therefore one aspect of the present invention to provide a contents transmission system capable of facilitating direct connection between a peripheral apparatus and a home server via a connector without requiring mediation of PC.

It is another aspect of the present invention to provide a method of playing contents using an integration media play program of a home server capable of providing convenience to users at the time of carrying out contents play by using an integration media play program which has integrated media play programs held by respective peripheral apparatuses.

It is yet another aspect of the present invention to provide a method of transmitting contents using a media format transcoding function within a home server capable of automatically transcoding a format of a predetermined audio/visual (A/V) file selected by a user to an A/V file format capable of being supported by a user's peripheral apparatuses.

It is still yet another object of the present invention to provide a method of automatically determining whether contents have been transmitted from a peripheral apparatus to a home server.

According to one aspect of the present invention, there is provided a contents transmission system including a home server, wherein the home server includes: a connector connected to a peripheral apparatus, and interfacing various information transceived between the connector and the peripheral apparatus; a contents storage storing contents; and a contents list management unit reading out a list of contents stored in the peripheral apparatus for determining whether the read list is same as a contents list stored in the home server, and based on this determination, receiving the previously untransmitted contents from the peripheral apparatus and storing the untransmitted contents in the contents storage.

Alternatively, the peripheral apparatus is a personal portable media player and may include a Dica-phone, a Camcorder-phone, an MP3-phone, an MP3 player, and a Personal Digital Assistant (PDA).

Alternatively, the connector may be manufactured in response to a specification of the peripheral apparatus.

Alternatively, the home server may further include: an adapter providing an interface compatibility between the home server and the peripheral apparatus when interface specifications between the connector of the home server and the peripheral apparatus do not match each other.

Alternatively, the home server may further include: a network interface unit enabling the home server to be connected to an Internet to carry out network communication; an apparatus kind determination unit determining a kind of the peripheral apparatus connected to the home server using a device identifier (ID) of the peripheral apparatus provided from the peripheral apparatus; an A/V format kind determination unit that determines the A/V format of the contents using file extension information of requested predetermined contents; a database storing a plurality of IDs, a plurality of codecs for decoding A/V files of various formats, and a plurality of transcoders for transcoding A/V files of a predetermined format to A/V files of another format compatible with respective peripheral apparatuses; and an application program storage storing an integration media play program as an application program used to decode an A/V file of contents requested for play, and a format transcoding application program as an application program used to transcode the A/V file format of the contents requested for play to an A/V file format capable of being decoded by the peripheral apparatus.

Alternatively, the home server may further include a controller enabling the integration media play program stored in the application program storage to be run so that an integration media player is operated.

Alternatively, the controller may read from the database information of codecs corresponding to the file format of the contents requested for play, check whether a codec matching the kind of the peripheral apparatus is among the codecs is stored in the database, and select the codec matching the peripheral apparatus and transmit it to the running integration media player when the codec matching the peripheral apparatus is stored in the database.

Alternatively, the controller, when the codec matching the peripheral apparatus is not stored in the database, connects to the Internet via the network interface unit, downloads a codec matching the peripheral apparatus connected to the home server, and transmits it to the running integration media player.

Alternatively, the integration media player may decode the A/V file of contents required to be played using the received codec while carrying out the play.

Alternatively, the home server may further include a controller enabling the format transcoding application program stored in the database to be run when it is necessary to transcode the A/V file format of the contents requested for play.

Alternatively, the controller may compare the A/V file format of the contents requested for play with the A/V file format capable of being decoded by the peripheral apparatus, and determines whether the format transcoding of the contents requested for play is necessary when the A/V file format of the contents requested for play does not match the A/V file format capable of being decoded by the peripheral apparatus.

Alternatively, the controller, when the format transcoding of the contents requested for play is necessary, preferably reads out from the database a predetermined transcoder for transcoding the A/V file format of the contents requested for play to the A/V format capable of being decoded by the peripheral apparatus, and then transmits the transcoder to the format transcoding application program.

According to another aspect of the present invention, there is provided a method of determining whether contents are transmitted, which includes: connecting a peripheral apparatus to a home server; reading out a list of contents stored in the peripheral apparatus, and determining whether the read list is same as a list of contents stored in the home server; when the list of contents stored in the home server does not match the list of the peripheral apparatus, receiving untransmitted contents from the peripheral apparatus and storing the untransmitted contents in the home server, and providing information about the contents list transmitted to the home server to the peripheral apparatus.

Alternatively, the method may further include enabling the peripheral apparatus to display a list of contents transmitted to the home server when the information about the contents list transmitted to the home server is provided from the home server to the peripheral apparatus.

According to yet another aspect of the present invention, there is provided a method of playing contents using an integration media play program, which includes: connecting a peripheral apparatus to a home server; checking a device ID of the peripheral apparatus and a file extension of contents requested for play; enabling the integration media play program stored in an application program storage to be run to operate an integration media player, determining a kind of the mounted peripheral apparatus using the device ID of the peripheral apparatus, and determining an A/V format kind of the contents requested for player using information of the file extension of the contents requested for play; reading out from a database information of codecs corresponding to the file format of the contents requested for play, and checking whether a codec corresponding to the kind of the peripheral apparatus among the codecs is stored in the database; when the codec corresponding to the kind of the peripheral apparatus among the codecs is stored in the database, selecting the codec matching the peripheral apparatus and transmitting the codec to the running integration media player; and enabling the integration media player to decode the A/V file of the contents requested for play using the received codec while carrying out the play.

Alternatively, the method may further include, when the codec corresponding to the kind of the peripheral apparatus is not stored in the database, connecting to an Internet via a network interface unit, downloading a codec matching the peripheral apparatus connected to the home server, transmitting the codec to the running integration media player; and enabling the integration media player to decode the A/V file of the contents requested for play using the received codec.

Alternatively, the kind of the peripheral apparatus is preferably determined by matching the device ID of the peripheral apparatus mounted in the home server with each of device IDs for apparatuses already stored in the database.

According to still yet another aspect of the present invention, there is provided a method of transmitting contents using a media format transcoding function, which includes: connecting a peripheral apparatus to a home server; checking an A/V file format capable of being decoded by the peripheral apparatus; checking whether format transcoding of contents requested for play is necessary; executing a format transcoding application program when the format transcoding of contents requested for play is necessary; reading out from a database a predetermined transcoder for transcoding the A/V file format of the contents requested for play to an A/V format capable of being decoded by the peripheral apparatus, and transmitting the transcoder to the format transcoding application program; and transcoding the A/V format of the contents requested for play to the A/V format capable of being played by the peripheral apparatus using the transcoder transmitted to the format transcoding application program, and transmitting to the peripheral apparatus the contents of which the file format is transcoded.

Alternatively, checking whether format transcoding of contents requested for play is necessary may include: comparing the A/V file format of the contents requested for play with the A/V file format capable of being decoded by the peripheral apparatus; and when the A/V file format of the contents requested for play does not match the A/V file format capable of being decoded by the peripheral apparatus, determining that format transcoding of the contents requested for play is necessary.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view illustrating contents transmission between a home server and a conventional peripheral apparatus (e.g., personal portable media player);

FIG. 2 is a block diagram illustrating a structure of a contents transmission system in accordance with an exemplary embodiment of the present invention;

FIG. 3 is a view illustrating a method of connecting the peripheral apparatus and the connector of FIG. 2;

FIG. 4 is a flow chart for explaining a method of determining whether contents are transmitted in accordance with a first exemplary embodiment of the present invention;

FIG. 5 is a flow chart for explaining a method of playing contents using an integration media play program in accordance with a second exemplary embodiment of the present invention;

FIG. 6 is a flow chart for explaining a method of transmitting contents using a media format transcoding function in accordance with a third exemplary embodiment of the present invention.

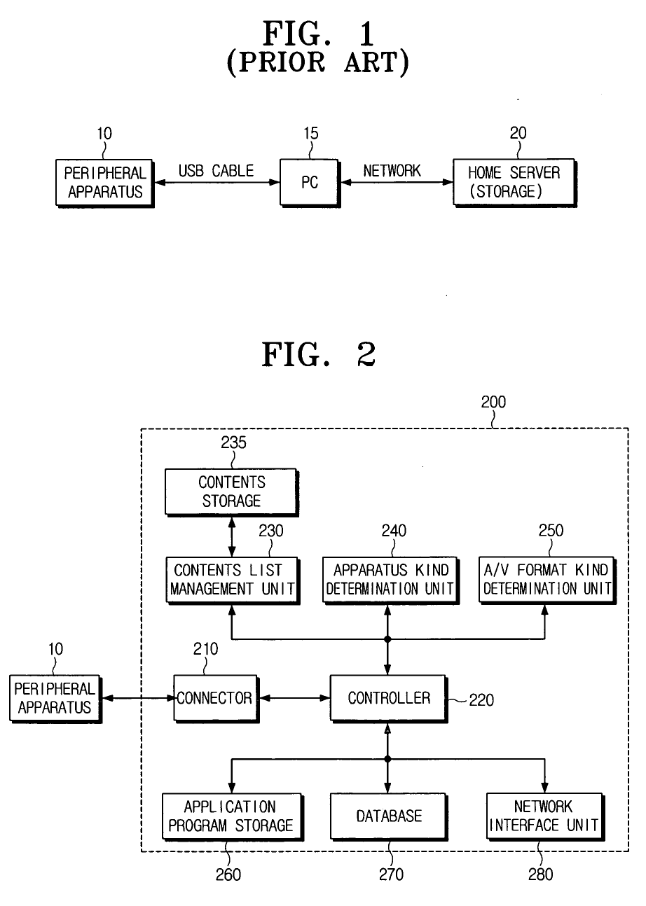

### DETAILED DESCRIPTION OF THE EXEMPLARY EMBODIMENTS

Hereinafter, exemplary embodiments of the present invention will be described in detail with reference to accompanying drawings.

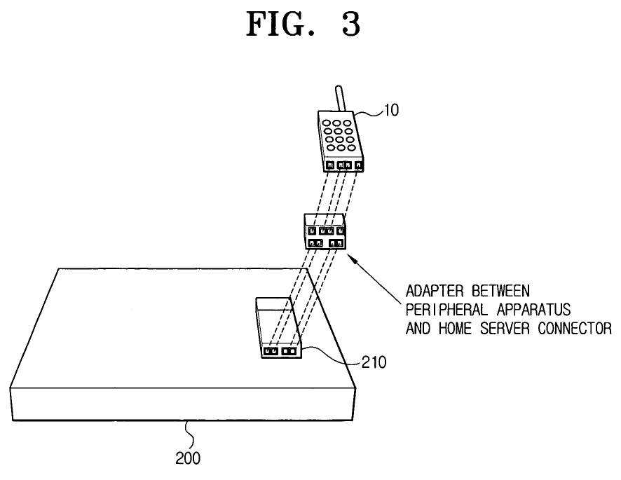

FIG. 2 is a block diagram illustrating a structure of a contents transmission system in accordance with an exemplary embodiment of the present invention. Referring to FIG. 2, the present contents transmission system includes a peripheral apparatus 10 and a homer server 200. The home server 200 is connected to the peripheral apparatus 10 via a connector 210. In this case, the peripheral apparatus 10 means a personal portable media player (PPMP) such as dica-phone, camcorder-phone, MP3-phone, MP3 player, PDA or the like.

The home server 200 includes a connector 210, a controller 220, a contents list management unit 230, a contents storage 235, an apparatus kind determination unit 240, A/V format kind determination unit 250, an application program storage 260, a database 270, and a network interface unit 280.

The controller 220 carries out general control on the home server 200. The connector 210 connects the home server 200 and the peripheral apparatus 10 and interfaces various information transceived between the home server 200 and the peripheral apparatus 10.

The contents list management unit 230 reads out a list of contents stored in the peripheral apparatus 10, and determines whether the read contents list is same as the contents list stored in the contents storage 235 of the home server 200. If it is determined that the contents list stored in the home server 200 is not same as that of the peripheral apparatus 10, the contents list management unit 230 receives contents not stored in the contents storage 235 of the home server 200 from the peripheral apparatus 10, stores them in the contents storage 235, and provides to the peripheral apparatus 10 information about the contents list transmitted to the home server 200.

The apparatus kind determination unit 240 determines the kind of the peripheral apparatus 10 mounted on the home server 200 using a device ID of the peripheral apparatus 10 provided from the peripheral apparatus 10. The A/V format determination unit 250 determines kinds of the A/V formats of contents using file extension information of the contents.

The application program storage 260 stores various application programs. In particular, the application program storage 260 stores an integration media play program which is an application program used to decode the A/V file of the contents requested for play, and a format transcoding application program which is an application program used to transcode the A/V file format of the contents requested for play to an A/V file format capable of being decoded by the peripheral apparatus 10.

The database 270 stores a plurality of IDs of devices, a plurality of codecs for decoding A/V files of various formats, and a plurality of transcoders for transcoding A/V files of predetermined format to A/V files of another format in response to kinds of respective peripheral apparatuses.

The network interface unit 280 has a wireless Local Area Network (LAN) card which enables the home server 200 to be connected to an Internet for carrying out network communication.

FIG. 3 is a view illustrating a method of connecting the peripheral apparatus and the connector of FIG. 2. Referring to FIG. 3, the homer server 200 and the peripheral apparatus 10 are not connected to each other via a separate USB cable as is done in the related art, but the peripheral apparatus 10 is mounted on the connector 210 of the homer server 200 so that the peripheral apparatus 10 and the home server 200 are connected to each other. In this case, the connector 210 of the home server 200 may be variously manufactured in response to specifications of peripheral apparatuses. In addition, when interface specifications between the connector 210 of the home server 200 and the peripheral apparatus 10 do not match each other, a separate adapter is preferably employed to provide an interface compatibility between the home server 200 and the peripheral apparatus 10.

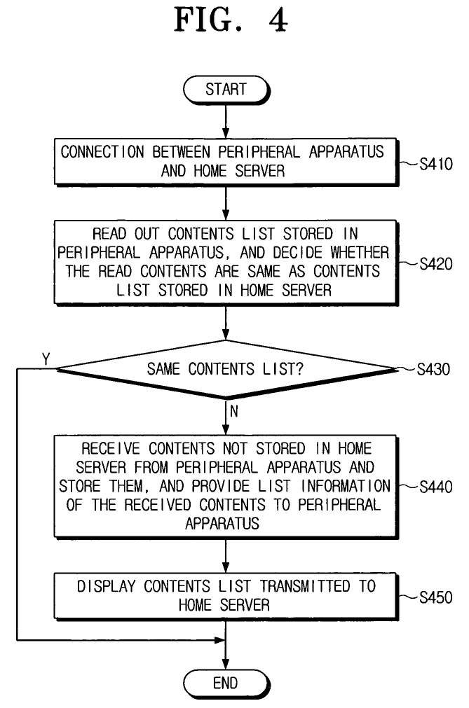

FIG. 4 is a flow chart for explaining a method of determining whether contents are transmitted in accordance with a first exemplary embodiment of the present invention. Referring to FIG. 4, the peripheral apparatus 10 is first mounted on the connector 210 of the home server 200 so that the peripheral apparatus 10 and the home server 200 are connected (S410). Subsequently, the contents list management unit 230 of the home server 200 reads out the list of contents stored in the peripheral apparatus 10, and determines whether the read contents list is same as the contents list stored in the contents storage 235 of the home server 200 (S420).

If the contents list stored in the home server 200 is the same as that of the peripheral apparatus 10 (S430:Y), contents stored in the peripheral apparatus 10 have all been transmitted to the home server 200, so no separate operations need be carried out.

If the contents list stored in the home server 200 is not same as that of the peripheral apparatus 10 (S430:N), not all contents stored in the peripheral apparatus 10 have been transmitted to the home server 200. In this case, the contents list management unit 230 receives contents which are not stored in the content storage 235 of the home server 200 from the peripheral apparatus 10, stores them in the contents storage 235, and provides to the peripheral apparatus 10 information about the contents list transmitted to the home server 200 (S440).

If the information about the contents list transmitted to the home server 200 are provided from the home server 200 to the peripheral apparatus 10, the peripheral apparatus 10 enables the contents list transmitted to the home server 200 to be displayed so that a user recognizes the list (S450). Accordingly, contents, which are stored in the peripheral apparatus 10 but are not transmitted to the home server 200, are automatically discriminated from those previously transmitted, and are then transmitted to the home server 200.

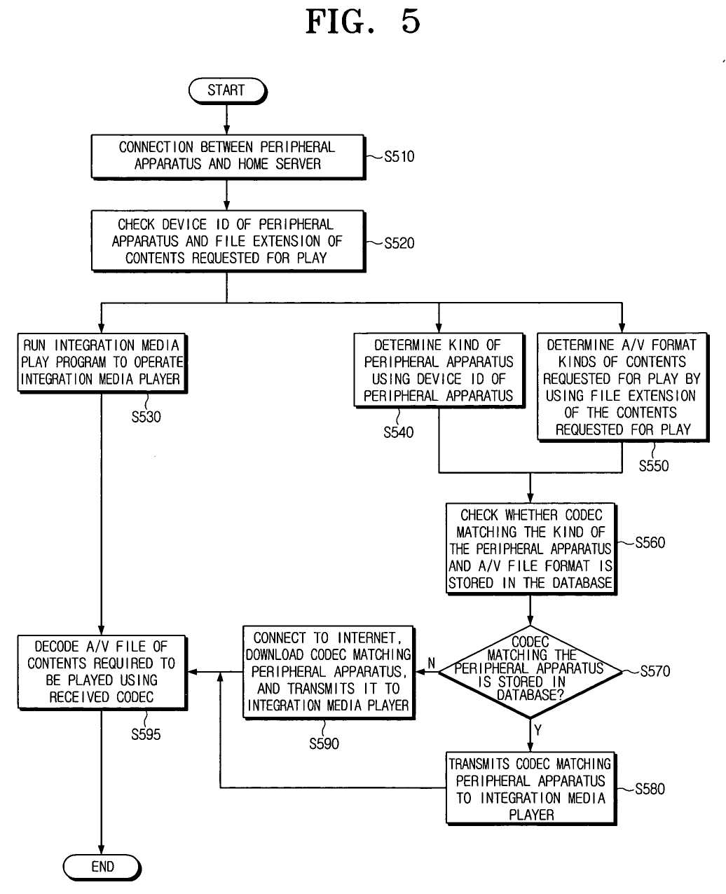

FIG. 5 is a flow chart for explaining a method of playing contents using an integration media play program in accordance with a second exemplary embodiment of the present invention. Referring to FIG. 5, the peripheral apparatus 10 is first mounted on the connector 210 of the home server 200 so that the peripheral apparatus 10 and the home server 200 are connected (S510). When the peripheral apparatus 10 and the home server 200 are connected to each other, the controller 220 checks the device ID of the peripheral apparatus 10 and the file extension of contents requested for play (S520).

Subsequently, the controller executes an integration media play program stored in the application program storage 260. Accordingly, the integration media play program is run to operate the integration media player (S530).

At the same time, information about the device ID of the peripheral apparatus 10 and information about the file extension of the contents requested for play, which are checked by the controller, are provided to the respective apparatus kind determination unit 240 and the A/V format kind determination unit 250. The apparatus kind determination unit 240 determines the kind of the peripheral apparatus 10 mounted in the home server 200 using the device ID of the peripheral apparatus 10 provided from the peripheral apparatus 10 (S540). More specifically, the apparatus kind determination unit 240 determines the apparatus kind by matching the device ID of the peripheral apparatus 10 mounted in the home server 200 with each of device IDs per apparatuses already stored in the database 270. Information about kinds of the peripheral apparatuses corresponding to the device IDs of various peripheral apparatuses 10 is stored in the database 270. Accordingly, the information about the kind of the peripheral apparatus 10 checked by the apparatus kind determination unit 240 is provided to the controller 220.

In addition, the A/V format kind determination unit 250 determines A/V format kinds of contents requested for play by using the file extension information of the contents requested for play (S550). The A/V format kind determination unit 250 provides the information about the file format kind of the contents requested for play to the controller 220. The controller 220 reads out from the database 270 information of codecs corresponding to the file format of the corresponding contents, and checks whether a codec matching the kind of the peripheral apparatus 10 among the codecs is stored in the database 270 (S560).

Upon checking, when the codec matching the kind of the peripheral apparatus 10 is stored in the database 270 (S570: Y), the controller 220 selects the codec matching the peripheral apparatus 10 and transmits it to the running integration media player (S580). By way of example, the controller 220 transmits an MP3 codec to the integration media player when the peripheral apparatus 10 is an MP3 player, and transmits a Divx codec to the integration media player when the peripheral apparatus 10 is a Divx player.

Alternatively, when the codec matching the kind of the peripheral apparatus 10 is not stored in the database 270 (S570: N), the controller 200 is connected to the Internet via the network interface unit 280, downloads the codec matching the peripheral apparatus 10 connected to the home server 200, and transmits it to the running integration media player (S590).

The integration media player decodes the A/V file of contents required to be played using the received codec while carrying out the play (S595).

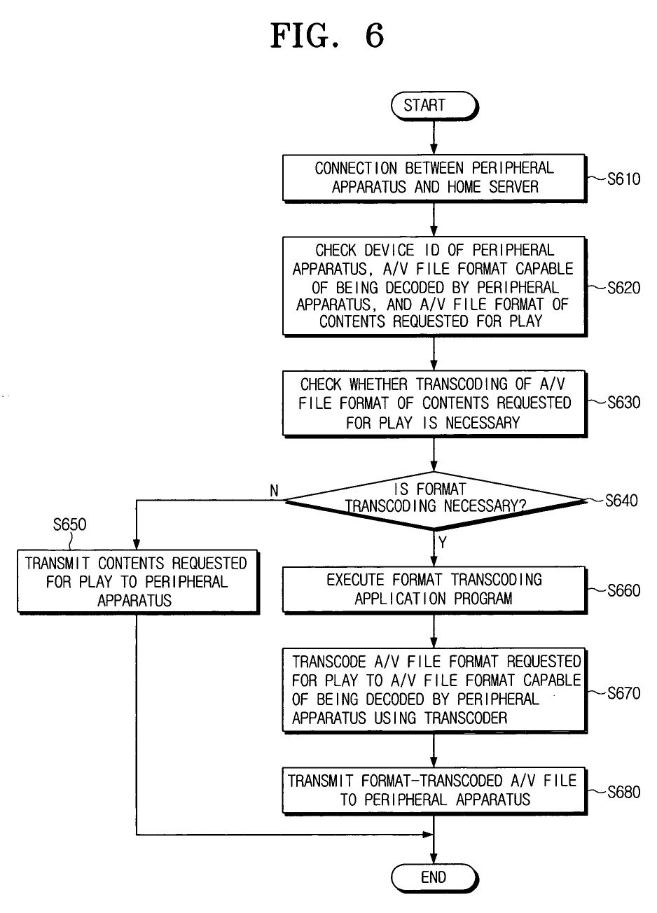

FIG. 6 is a flow chart for explaining a method of transmitting contents using a media format transcoding function in accordance with a third exemplary embodiment of the present invention. Referring to FIG. 6, the peripheral apparatus 10 is first mounted on the connector 210 of the home server 200 so that the peripheral apparatus 10 and the home server 200 are connected (S610).

When the peripheral apparatus 10 and the home server 200 are connected, the apparatus kind determination unit 240 checks the A/V file format capable of being decoded by the peripheral apparatus 10 and the file extension of contents requested for play using the device ID of the peripheral apparatus 10 (S620). The apparatus kind determination unit 240 determines the kind of the peripheral apparatus 10 mounted in the home server 200 using the device ID of the peripheral apparatus 10 provided from the peripheral apparatus 10. In addition, the A/V format kind determination unit 250 determines the A/V format kind of contents requested for play using the file extension information of the contents requested for play.

Subsequently, the controller 220 checks whether format transcoding of the contents requested for play is necessary (S630). Whether the format transcoding of the contents requested for play is necessary is determined by whether the peripheral apparatus 10 mounted in the home server 200 can decode the A/V file format of the contents requested for play. To this end, the controller 220 compares the A/V file format of the contents requested for play with the A/V file format capable of being decoded by the peripheral apparatus 10. Upon comparison, if they are same as each other, which corresponds to a case that does not require the format transcoding (S640:N), so that the controller 220 transmits the contents requested for play to the peripheral apparatus 10 as it is (S650).

Alternatively, if the A/V file format capable of being decoded by the peripheral apparatus 10 is not same as the A/V file of the contents requested for play, the peripheral apparatus 10 cannot decode the A/V file of the contents requested for play, so that it is required to transcode the A/V file format of the contents requested for play. As such, if it is required to transcode the A/V file format of the contents requested for play (S640:Y), the controller 220 executes the format transcoding application program stored in the application program storage 260 (S660). When the format transcoding application program is run by the control of the controller 220, the controller 220 reads out from the database 270 a predetermined transcoder for transcoding the A/V format of the contents requested for play to the A/V format capable of being played in the peripheral apparatus 10, and transmits it to the format transcoding application program.

The format transcoding application program transcodes the A/V format of the contents requested for play to the A/V format capable of being played in the peripheral apparatus 10 using the transcoder received from the controller 220 (S670). Subsequently, the controller 220 transmits the contents of which the file format is transcoded by the transcoding of the transcoding application program to the peripheral apparatus 10 (S680).

Accordingly, the peripheral apparatus 10 receives the transcoded file format for decoding the same so that it can play the contents requested for play.

As mentioned above, according to the present invention differing from the conventional contents transmission structure requiring the PC, a more facilitated connectivity can be provided to a user via a direct connection between the home server and the personal portable media player.

Furthermore, according to the present invention, more convenience can be provided to a user at the time of playing contents using the integration media play program which has integrated media play programs held by respective peripheral apparatuses.

Further, according to the present invention, the format of the predetermined A/V file selected by a user can be automatically transcoded to a format of A/V file capable of being supported by the peripheral apparatus, so that more convenience can be provided to a user.

Further, according to the present invention, whether the contents have been transmitted from the PPMP to the home server can be automatically determined, so that more convenience can be provided to a user.

The foregoing embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A contents transmission system comprising:
a home server;
a peripheral apparatus that stores and plays content; and
a connector that connects the peripheral apparatus to the home server and interfaces various information between the server and the peripheral apparatus,
wherein the home server comprises:
a contents storage storing content; and
a contents list management unit that reads out a list of peripheral apparatus content stored in the peripheral apparatus, determines whether the list is the same as the content stored in the contents storage, and receives peripheral apparatus content not stored in the contents storage.

2. The contents transmission system according to claim 1, wherein the peripheral apparatus is of one a Dica-phone, a Camcorder-phone, an MP3-phone, an MP3 player, and a Personal Digital Assistants (PDA).

3. The contents transmission system according to claim 1, wherein the connector complies with a specification of the peripheral apparatus.

4. The contents transmission system according to claim 1, further comprising an adapter that provides an interface compatibility between the home server and the peripheral apparatus if interface specifications between the connector of the home server and the peripheral apparatus do not match.

5. The contents transmission system according to claim 1, wherein the home server further comprises:
a network interface unit that enables the home server to be connected to the Internet to carry out network communication;
an apparatus kind determination unit that determines a type of peripheral apparatus connected to the home server using a device identifier (ID) of the peripheral apparatus provided from the peripheral apparatus;
an audio/visual (A/V) format kind determination unit that determines an A/V format of content using file extension information of contents requested via the peripheral apparatus;
a database that stores a plurality of IDs, a plurality of codecs for decoding A/V files of various formats, and a plurality of transcoders for transcoding A/V files of predetermined format to A/V files of another format in response to kinds of respective peripheral apparatuses; and
an application program storage that stores an integration media play program as an application program used to decode an A/V file of contents requested for play using one of said plurality of codecs, and a format transcoding application program as an application program used to transcode the A/V file format of the contents requested for play, using one of the plurality of transcoders, to an A/V file format capable of being played by the peripheral apparatus.

6. The contents transmission system according to claim 5, wherein the home server further comprises a controller that enables the integration media play program stored in the application program storage to be run so that an integration media player is operated.

7. The contents transmission system according to claim 6, wherein the controller reads out from the database information of codecs corresponding to the file format of the contents requested for play, determines whether a codec matching the kind of the peripheral apparatus among the codecs is stored in the database, and selects the codec matching the peripheral apparatus and transmits the selected codec to the running integration media player if it is determined that the codec matching the peripheral apparatus is stored in the database.

8. The contents transmission system according to claim 7, wherein the controller, if it is determined that the codec matching the peripheral apparatus is not stored in the database, is connected to the Internet via the network interface unit, downloads a codec matching the peripheral apparatus connected to the home server, and transmits the downloaded codec to the running integration media player.

9. The contents transmission system according to claim 7, wherein the integration media player decodes the A/V file of content required to be played using the received codec while carrying out the play.

10. The contents transmission system according to claim 5, wherein the home server further comprises a controller that enables the format transcoding application program stored in the application program storage to be run if it is necessary to transcode the A/V file format of the contents requested for play.

11. The contents transmission system according to claim 10, wherein the controller compares the A/V file format of the contents requested for play with the A/V file format capable of being decoded by the peripheral apparatus, and determines that the format transcoding of the contents requested for play is necessary if the A/V file format of the contents requested for play does not match the A/V file format capable of being decoded by the peripheral apparatus.

12. The contents transmission system according to claim 10, wherein the controller, if the format transcoding of the contents requested for play is necessary, reads out from the database a predetermined transcoder for transcoding the A/V file format of the contents requested for play to the A/V format capable of being decoded by the peripheral apparatus, and transmits the transcoder to the format transcoding application program.

13. A method of determining whether contents are transmitted, the method comprising:
connecting a peripheral apparatus to a home server;
reading out a list of contents stored in the peripheral apparatus, and determining whether the read list is same as a list of contents stored in the home server;
receiving untransmitted contents from the peripheral apparatus and storing the untransmitted contents in the home server if the list of contents stored in the home server does not match the list of the peripheral apparatus; and
providing information about the contents list transmitted to the home server to the peripheral apparatus.

14. The method according to claim 13, further comprising enabling the peripheral apparatus to display a list of contents transmitted to the home server when the information about the contents list transmitted to the home server is provided from the home server to the peripheral apparatus.

15. A method of playing contents using an integration media play program, the method comprising:
connecting a peripheral apparatus to a home server;
checking a device identifier (ID) of the peripheral apparatus and a file extension of contents requested for play on the peripheral apparatus;
enabling the integration media play program stored in an application program storage to be run to operate an integration media player;
determining a kind of the peripheral apparatus using the device ID of the peripheral apparatus;
determining an audio/visual (A/V) format kind of the contents requested for play using information of the file extension of the contents requested for play;
reading out from a database information of codecs corresponding to the the A/V format kind of the contents requested for play, and determining whether a codec corresponding to the kind of the peripheral apparatus among the codecs is stored in the database;
selecting the codec matching the peripheral apparatus if the codec corresponding to the kind of the peripheral apparatus among the codecs is stored in the database, and transmitting the codec to the operating integration media player; and
enabling the integration media player to decode the A/V file of the contents requested for play using the received codec while carrying out the play.

16. The method according to claim 15, further comprising:
connecting to the Internet via a network interface unit if the codec corresponding to the kind of the peripheral apparatus is not stored in the database, downloading a codec matching the peripheral apparatus connected to the home server from the Internet, and transmitting the codec to the running integration media player; and
enabling the integration media player to decode the A/V file of the contents requested for play using the downloaded codec while carrying out the play.

17. The method according to claim 15, wherein the kind of the peripheral apparatus is determined by matching the device ID of the peripheral apparatus connected to the home server with each of device IDs stored in the database.

18. A method of transmitting contents using a media format transcoding function, the method comprising:
connecting a peripheral apparatus to a home server;
determining an audio/visual (A/V) file format capable of being decoded by the peripheral apparatus;
determining whether format transcoding of contents requested for play is necessary;
executing a format transcoding application program when the format transcoding of contents requested for play is necessary;
reading out from a database a predetermined transcoder for transcoding the A/V file format of the contents requested for play to an A/V format capable of being decoded by the peripheral apparatus, and transmitting the transcoder to the format transcoding application program; and
transcoding the A/V format of the contents requested for play to the A/V format capable of being played by the peripheral apparatus using the transcoder transmitted to the format transcoding application program, and transmitting to the peripheral apparatus the contents of which the file format is transcoded.

19. The method according to claim 18, wherein the determining whether format transcoding of contents requested for play is necessary comprises:
comparing the A/V file format of the contents requested for play with the A/V file format capable of being decoded by the peripheral apparatus; and
determining that format transcoding of the contents requested for play is necessary if the A/V file format of the contents requested for play does not match the A/V file format capable of being decoded by the peripheral apparatus.

20. A contents transmission system comprising:
a peripheral apparatus that stores and plays content; and
a connector that connects the peripheral apparatus to a home server and interfaces various information between the server and the peripheral apparatus,
wherein the home server comprises:
a controller enabling an integration media play program stored in the application program storage to be run so that an integration media player is operated;
a network interface unit enabling the home server to be connected to an Internet to carry out network communication;
an apparatus kind determination unit that determines a type of peripheral apparatus is connected to the home server using a device identifier (ID) of the peripheral apparatus provided from the peripheral apparatus;
an audio/visual (A/V) format kind determination unit that determines an A/V format of content using file extension information of contents requested via the peripheral apparatus;
a database that stores a plurality of IDs, a plurality of codecs for decoding A/V files of various formats, and a plurality of transcoders for transcoding A/V files of predetermined format to A/V files of another format in response to types of respective peripheral apparatuses; and
an application program storage that stores the integration media play program as an application program used to decode an A/V file of contents requested for play using one of the plurality of codecs, and a format transcoding application program as an application program used to transcode the A/V file format of the contents requested for play, using one of the plurality of transcoders, to an A/V file format capable of being played by the peripheral apparatus.
